(19) United States
(12) Patent Application Publication
(10) Pub. No.: US 2006/0046242 A1
(43) Pub. Date: Mar. 2, 2006

(54) Method and apparatus for providing product information, and computer product

(75) Inventors: Kosei Takano, Tokyo (JP); Kenji Sakata, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki-shi (JP)

(21) Appl. No.: 11/237,695

(22) Filed: Sep. 29, 2005

Related U.S. Application Data
(63) Continuation of application No. PCT/JP03/06394, filed on May 22, 2003.

(51) Int. Cl. G09B 25/00

(52) U.S. Cl. 434/365; 434/323

(57) ABSTRACT

An apparatus for providing various pieces of information related to a product that requires a proper disposal by a consumer to a client apparatus of the consumer via a network includes an educating unit that conducts an education related to a disposal of the product for the consumer via the client apparatus; and an education-history storing unit that stores a progress of the education conducted, as an education history.

### BACKGROUND OF THE INVENTION

1. Field of the Invention

The present invention relates to a technology for providing various pieces of information related to a product that requires a proper disposal by a consumer to the consumer via a network.

2. Description of the Related Art

Conventionally, consumers are required to properly dispose of various products, which eventually become useless after they are purchased. For example, the inside of aluminum cans for drinks are to be rinsed before the cans are disposed of as recyclable garbage, labels on PET bottles are to be removed before the bottles are disposed of as non-flammable garbage, and refrigerators and televisions are to be disposed of in accordance with regulations related to recycling of electric home appliances.

One example of a conventional art for realizing proper disposal of such products is disclosed in Japanese Patent Application Laid-Open Publication No. 2002-163422. According to the publication, a server in a service providing company connected to self-governing bodies, homes, and manufacturers through a network generates “garbage separating disposal method presenting data”. The server prints out the data as a pamphlet to present the “garbage separating disposal method” in a manner such that the presentation also acts as an advertisement for the product.

However, such server systems still fail to facilitate consumers to fully understand how to dispose of products. It is thus difficult for the consumers to actively cooperate,in utilizing resources effectively and contributing to a clean environment.

Further, environmental problems have become unavoidable for the human race. Even stock prices can be affected by measures taken by manufacturers against environmental problems. Therefore, manufacturers are faced with a problem that they are forced to add expenses for disposal and recycling of their products to prices of the products. Furthermore, self-governing bodies are spending enormous budgets on illegal disposal of refuses and recycling.

Therefore, it is very important to find ways to make consumers understand the processes for disposal of products for which proper disposal by the consumers is required or of products that become useless after being purchased. Moreover, frameworks for facilitating effective utilization and contributing to a clean environment are needed.

### SUMMARY OF THE INVENTION

It is an object of the present invention to solve at least the problems in the conventional technology.

An apparatus according to one aspect of the present invention, which is for providing various pieces of information related to a product that requires a proper disposal by a consumer to a client apparatus of the consumer via a network, includes an educating unit that conducts an education related to a disposal of the product for the consumer via the client apparatus; and an education-history storing unit that stores a progress of the education conducted, as an education history.

A method according to another aspect of the present invention, which is for providing various pieces of information related to a product that requires a proper disposal by a consumer to a client apparatus of the consumer via a network, includes conducting an education related to a disposal of the product for the consumer via the client apparatus; and storing a progress of the education conducted, as an education history.

A computer-readable recording medium according to still another aspect of the present invention stores a computer program that causes a computer to execute the above method according to the present invention.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram of a structure of an educational system according to a first embodiment of the present invention;

FIG. 2 is a flow chart of steps carried out in the educational system;

FIG. 3 is a block diagram of a structure of an education server apparatus;

FIG. 4 is a diagram of an example of a structure of a customer master;

FIG. 5 is a diagram of an example of a structure of an educational course master;

FIG. 6 is a diagram of an example of a structure of an education master;

FIG. 7 is a diagram of an example of a structure of a discount table;

FIG. 8 is a diagram for explanation of steps carried out by an educating unit;

FIG. 9 is a block diagram of a structure of a store server apparatus;

FIG. 10 is a diagram of an example of a structure of a customer master;

FIG. 11 is a diagram of an example of a structure of a product master;

FIG. 12 is a diagram of an example of a structure of an accounting master;

FIG. 13 is a diagram for explanation of steps carried out by a product selling unit;

FIG. 14 is a diagram of an example of a structure of a product label;

FIGS. 15A and 15B are diagrams of screens displayed at a consumer terminal apparatus;

FIG. 16 is a diagram of an example of a structure of a discount accumulation table;

FIG. 17 is a diagram of a structure of a computer system according to a second embodiment of the present invention; and

FIG. 18 is a block diagram of a structure of a main body in the computer system illustrated in FIG. 17.

### DETAILED DESCRIPTION OF THE PREFERRED EMBODIMENTS

Exemplary embodiments of the present invention are explained in detail below with reference to the accompanying drawings. An educational system for realizing the present invention is presented first as one of the embodiments. Main terms used in the embodiments will be explained, followed by an outline and then characteristics of the educational system. A flow of an overall procedure in the educational system is then explained, followed by structures and processes related to an education server apparatus and a store server apparatus in the system. Lastly, various modifications as other of the embodiments are explained.

A term “product” used in the present embodiments refers to any merchandise or product that requires a proper disposal by consumers, such as an aluminum-canned drink, a PET bottle, a refrigerator, and a television, which become useless or end up being a refuse after being purchased by a consumer.

A term “education” refers to e-learning or education using the Internet which is related to disposal of a product, such as an educational course titled “What is Electric Home Appliance Recycling Law?” or “Recycling of PET Bottles”, which facilitates understanding of proper disposal or recycling of the product.

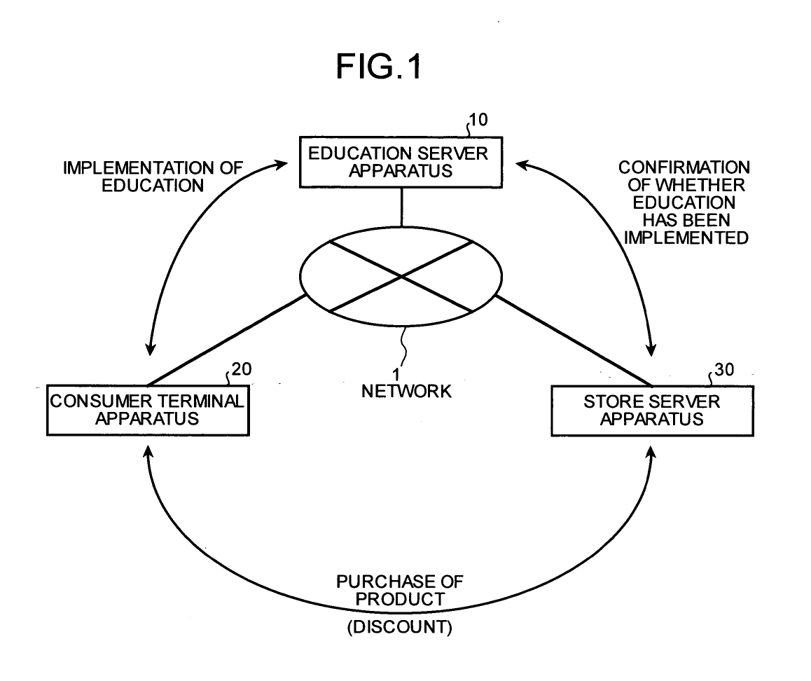

FIG. 1 is a diagram of an overall structure of an educational system according to a first embodiment of the present invention. The educational system has an education server apparatus 10 of an educational institution, a consumer terminal 20 of a consumer or customer, and a store server apparatus 30 of a store, which are connected to each other via a network 1 such as the Internet so that the apparatuses are able to communicate with each other.

Generally, the education server apparatus 10 and the store server apparatus 30 in cooperation with each other provide various pieces of information to the consumer terminal apparatus 20 of the consumer via the network 1. This information relates to various products sold by the store, i.e., to products for which proper disposal is required after being purchased by the consumer. The consumer terminal apparatus 20 may be a personal computer, a work station, a home video game, an internet television, a personal data assistant (PDA), or a mobile communications terminal such as a cellular phone or a personal-handyphone-system(PHS) phone.

One of the main characteristics of the system is in procedures carried out by the education server apparatus 10. The education server apparatus 10 implements for the customer through the consumer terminal apparatus 20 education that facilitates understanding of proper disposal of or recycling procedure for a product that becomes useless after being purchased by the consumer. That is, the education server apparatus 10 facilitates the consumer's understanding related to the disposal of the product through the education, so as to urge the consumer to actively cooperate in effectively utilizing resources and contributing to a clean environment. As a result, manufacturers and self-governing bodies are able to pay less for environmental problems and to facilitate effective utilization of resources and contribution to a clean environment.

The system additionally has the following characteristics. The education server apparatus 10 provides an examination to the consumer to test an effect of the education. The provision of the examination stimulates motivation of the consumer. What is more, a level of the consumer's understanding can be represented objectively by a result of the examination so that the consumer's understanding is improved effectively and the consumer is able to gain solid understanding.

The store server apparatus 30 provides a discount to the consumer who has taken the education implemented by the education server apparatus 10, when the consumer purchases the product for which the education is implemented. Accordingly, this direct profit obtained at the time of purchasing the product is an incentive that directly stimulates the consumer's motivation to learn from the education and improves the consumer's understanding even more effectively.

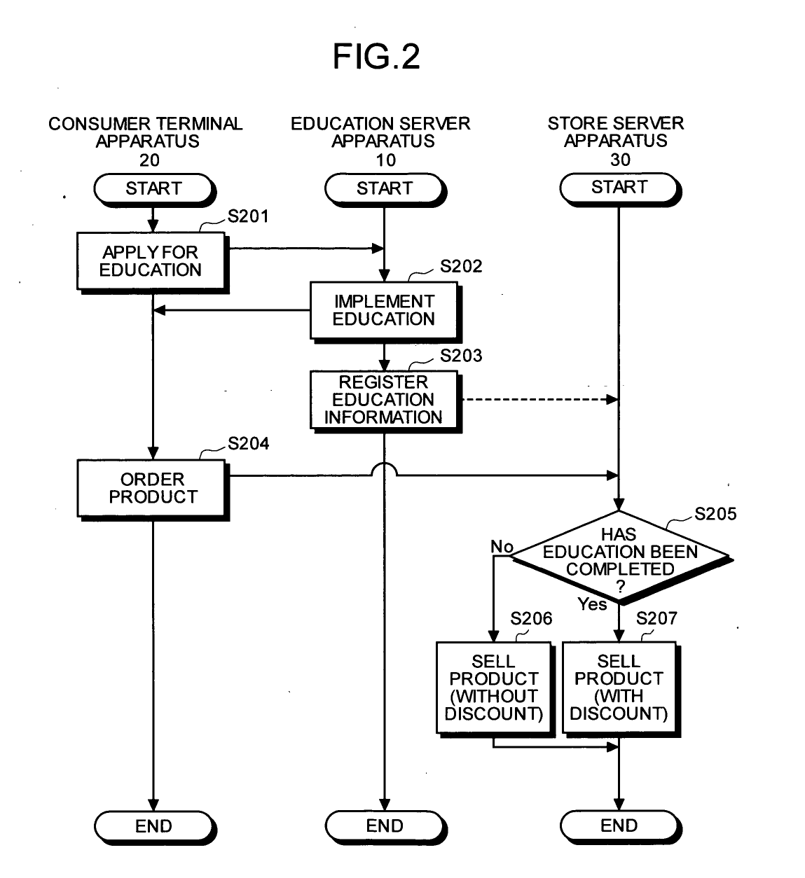

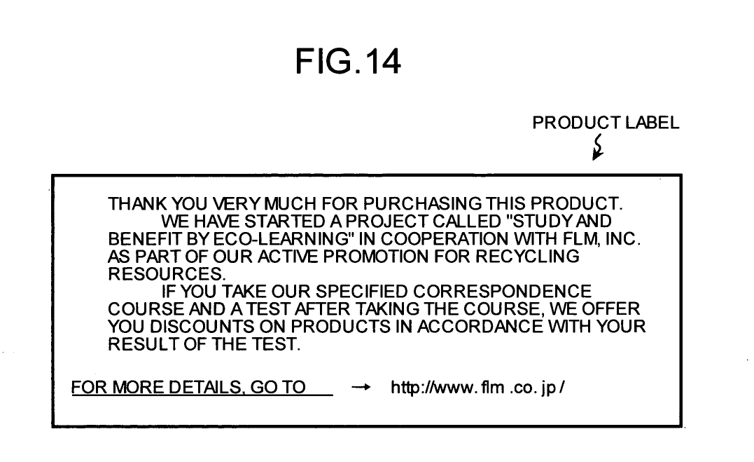

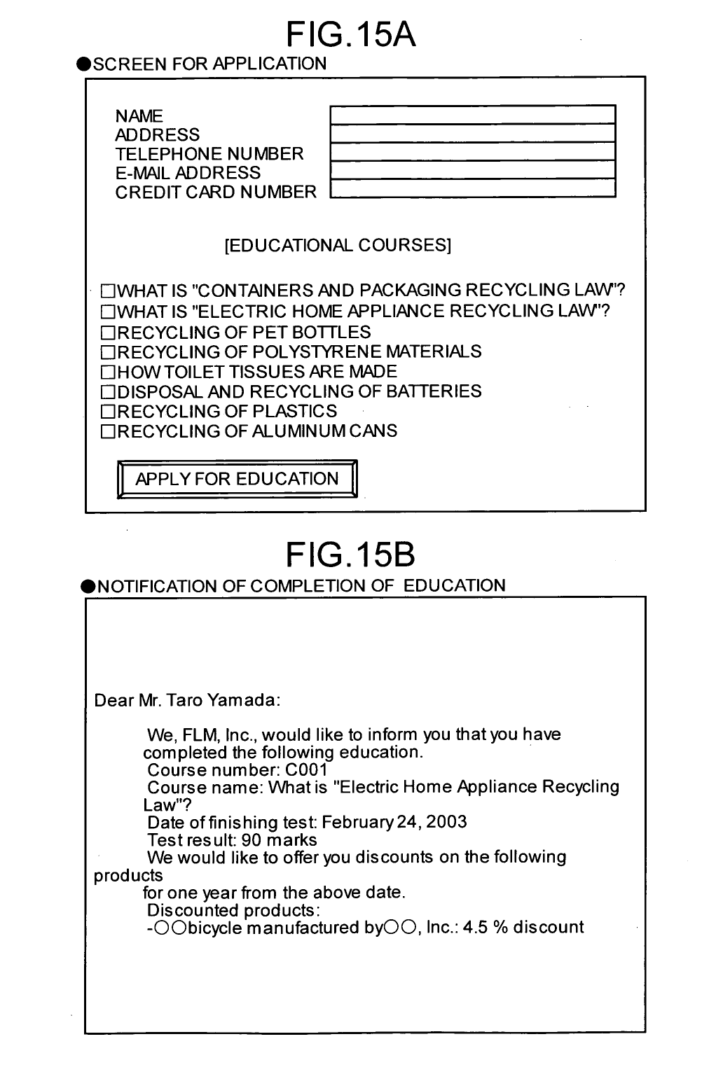

The flow of the overall procedure carried out in the system is now explained with reference to a flow chart in FIG. 2. A consumer purchases a product to which a product label as illustrated in FIG. 14 is attached and if the consumer is interested in an educational course implemented by the education server apparatus 10, as illustrated in FIG. 2 (Step S201), the consumer accesses the education server apparatus 10 via the consumer terminal apparatus 20 to apply for taking the educational course through a screen as shown in FIG. 15A.

In response, the education server apparatus 10 implements education (e-learning) related to a process of disposing or recycling of a product for the consumer who is now a student, in accordance with the educational course that has been applied for (Step S202). When the education is finished, the education server apparatus 10 provides a test to the student and records course information including a result of the test (Step S203). After the test is finished, the education server apparatus 10 transmits to the consumer terminal apparatus 20 a notification as shown in FIG. 15B for notifying a product or a list of products that are to be discounted now that the course is completed.

When the store server apparatus 30 receives from the consumer terminal apparatus 20 a purchasing order for a product (Step S204), the store server apparatus 30 determines whether or not the product ordered by the consumer is a target of discount and whether or not a corresponding educational course has been completed by the consumer (Step S205). If it is determined that the consumer has not completed the corresponding educational course (Step S205, NO), the store server apparatus 30 sells the product without any discount (Step S206). If it is determined that the consumer has completed the corresponding educational course (Step S205, YES), the store server apparatus 30 sells the product with a discount that is provided on condition that the corresponding educational course has been completed (Step S207).

Therefore, consumers are able to readily understand the proper process for disposal of products through the e-learning provided by the education server apparatus 10. Moreover, the consumers are able to purchase a product with a discount based on the educational course completed. As a result, consumers are facilitated to cooperate actively in effectively utilizing resources and contributing to a clean environment. Consequently, a win-win relationship is maintained between all players including the manufacturers consumers, self-governing bodies, and educational institutions. In addition, tax refunds and subsidies from self-governing bodies may be allotted to expenses for implementing education through the educational institutions and for the discounts provided by the stores.

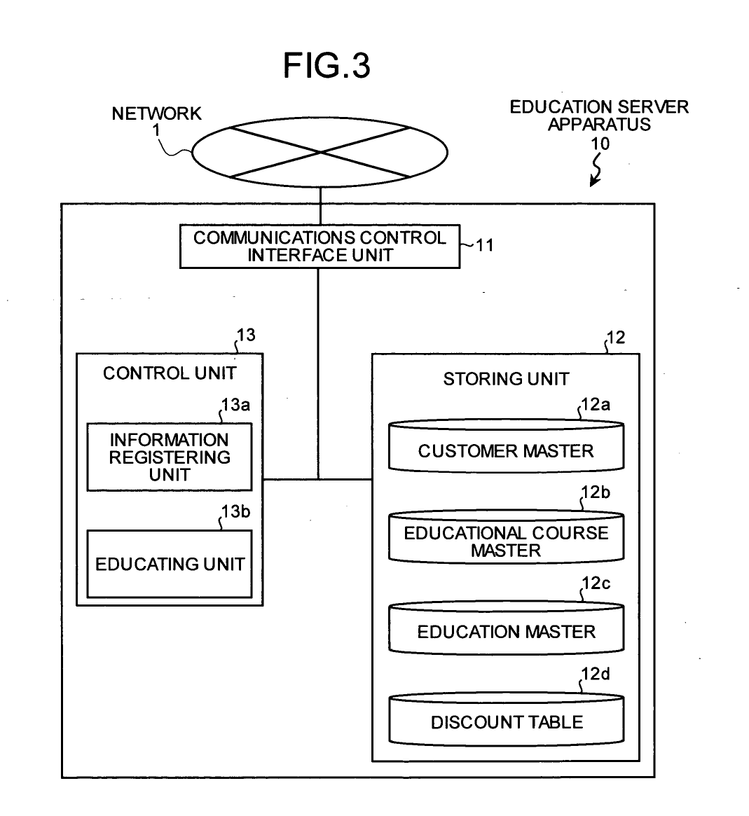

A structure and steps carried out by the education server apparatus 10 in the educational system according to the first embodiment is now explained with reference to FIGS. 3 to 8. FIG. 3 is a block diagram of a structure of the education server apparatus 10. The education server apparatus 10 includes a communications control interface unit 11 that controls communications related to data exchanged via the network 1 between the education server apparatus 10 and the consumer terminal apparatus 20 and between the education server apparatus 10 and the store server apparatus 30. The education server apparatus 10 also includes a storing unit 12 and a control unit 13 which are explained in detail below.

The storing unit 12 is a storing means (memory means) that stores data required for various processes executed by the control unit 13, for example, Web data transmitted to and displayed at the consumer terminal apparatus 20, and a program. The storing unit 12 functionally includes a customer master 12a, an educational course master 12b, an education master 12c, and a discount table 12d, which are elements particularly closely related to the present invention.

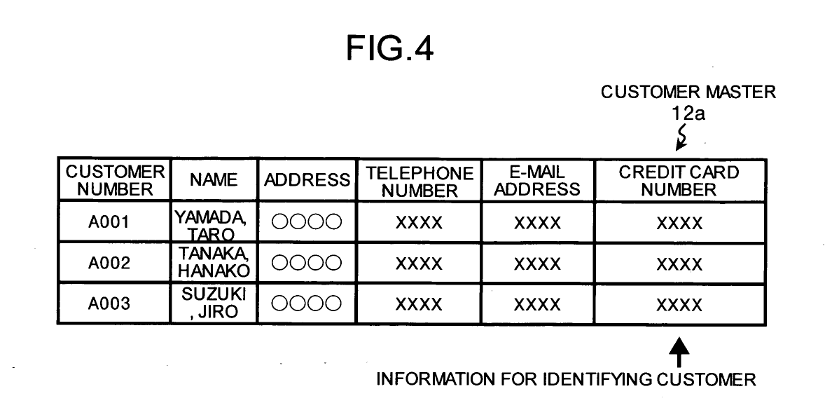

The customer master 12a is a means for storing various pieces of personal information related to the consumer or a customer who takes an education from the education server apparatus 10. For example, as shown in FIG. 4, a name, an address, a telephone number, an e-mail address, and a credit card number are stored in the customer master 12a correspondingly with a customer number for each consumer.

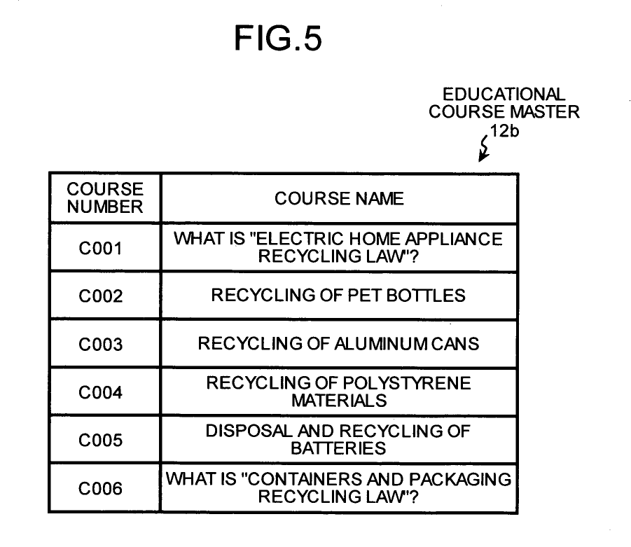

The educational course master 12b is a means for storing various pieces of information related to the education implemented by the education server apparatus 10. For example, as shown in FIG. 5, a course name and educational contents included in each educational course are stored in the educational course master 12b correspondingly with a course number for each educational course. The educational contents may be e-mail data or Web data that is transmitted to and displayed at the consumer terminal apparatus 20.

The educational contents are for educational courses helpful to understanding proper disposal and recycling of a product. The education may be practical education for teaching garbage separating standards (for example for determining whether a garbage is classified into flammable garbage, non-flammable garbage, recyclable garbage, and a refuse to which regulations for recycling of electric home appliances apply) and how to throw out garbage (for example, that the inside of aluminum drink cans is rinsed and that labels on pet bottles are removed). The education may also include social education (education for improving morals) for teaching merits of following the proper disposal of garbage (for example, cost reduction for self-governing bodies and environmental protection) and demerits of not following the proper disposal (for example increase in cost for self-governing bodies and environmental disruption).

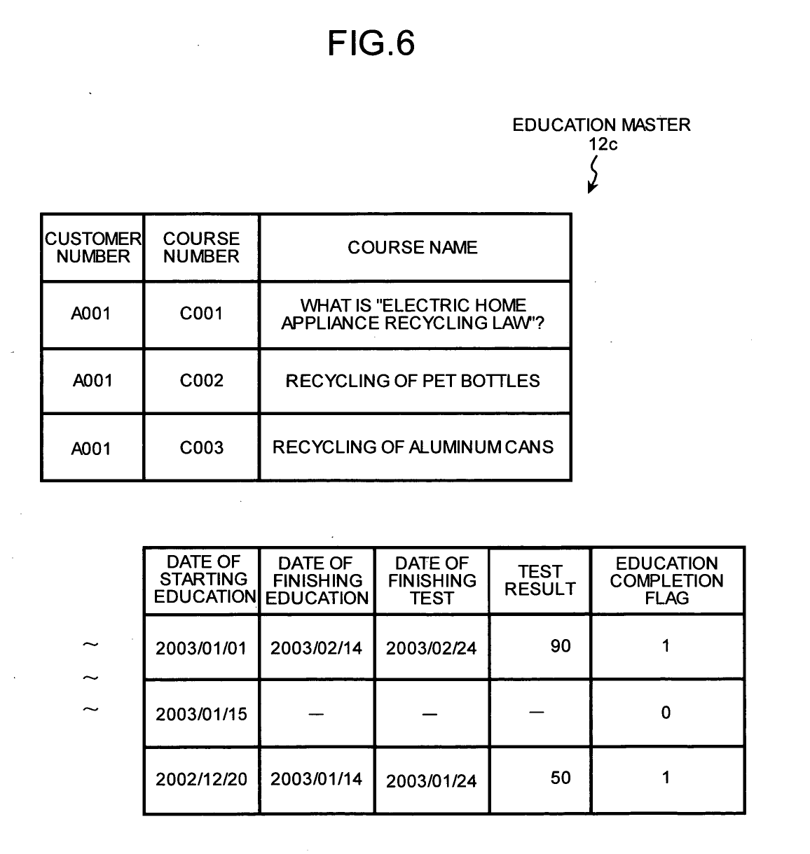

The education master 12c is a means for storing a progress of the education taken by the student as a history. For example, as shown in FIG. 6, a customer number, a course number, a course name, a date of starting the course, a date of finishing the course, a date of finishing a test, a test result, and a flag for indicating whether the course has been completed (which is “0” before completion) are stored in the education master 12c correspondingly with the education number.

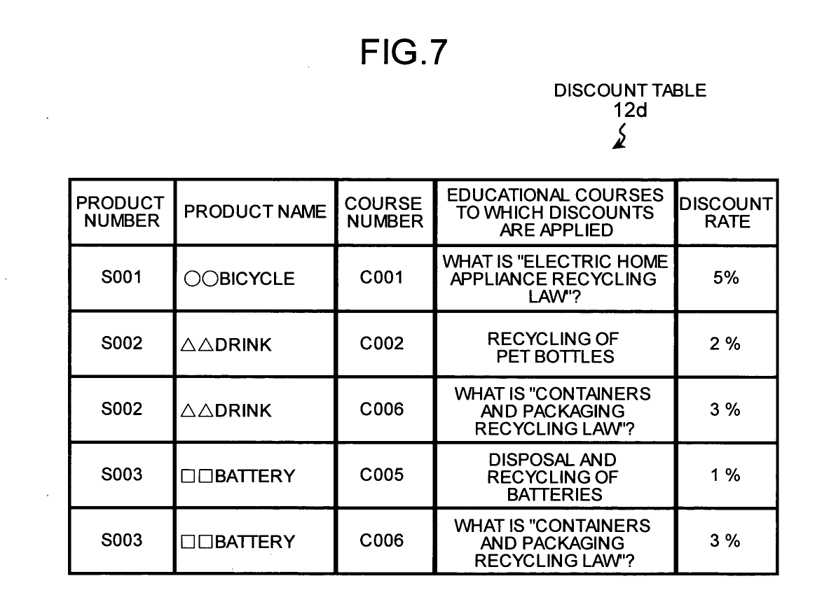

The discount table 12d is a means for storing information related to discounts provided as a result of implementing the educational courses. For example, as shown in FIG. 7, a product name, a course number of the educational course to which a discount is applied, an educational course name, and a discount rate are stored in the discount table 12d correspondingly with a product number for each product.

The control unit 13 in the education server apparatus 10 shown in FIG. 3, is a processing unit that includes an internal memory for storing a control program such as an operating system, a program which defines various processes (for example a program for authenticating a customer), and data. The control unit 13 executes various processes using these programs and data. The control unit 13 functionally includes an information registering unit 13a and an educating unit 13b, which are elements closely related to the present invention.

The information registering unit 13a is a processing unit that registers corresponding information into the customer master 12a, the educational course master 12b, the education master 12c, and the discount table 12d of the storing unit 12. The information registering unit 13a registers the information cooperatively with the educating unit 13b into the customer master 12a and the education master 12c.

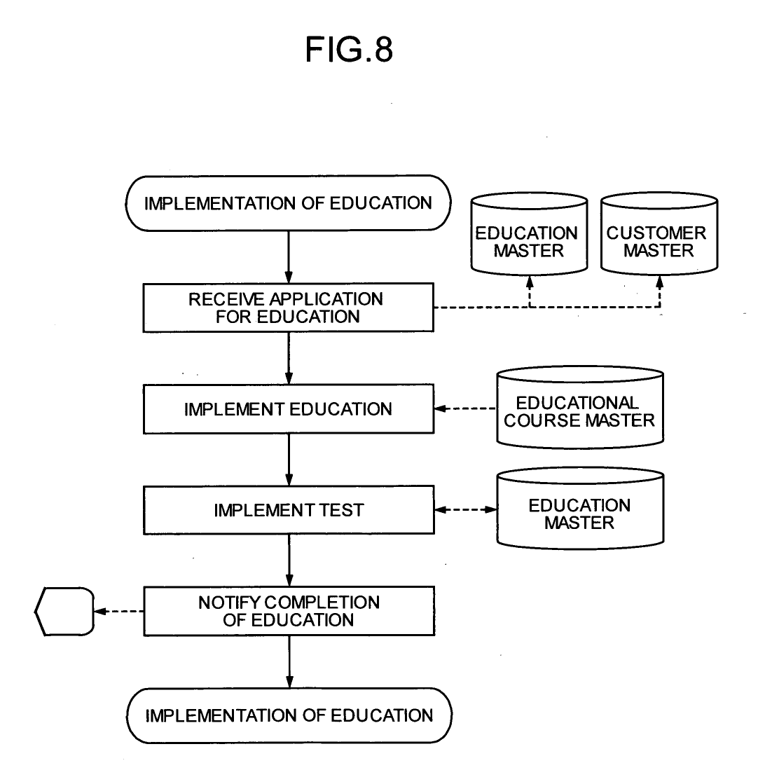

As shown in FIG. 8, the educating unit 13b is a processing unit that executes various processes related to implementation of the education. That is, the educating unit 13b transmits to and displays at the consumer terminal apparatus 20 contents as shown in FIG. 15A and receives from the consumer terminal apparatus 20 of the consumer an application for an educational course. The educating unit 13b then registers the personal information of the consumer into the customer master 12a (FIG. 4) and registers information related to the application into the education master 12c (FIG. 6). The educating unit 13b reads out the educational contents (educational course) to be implemented for each customer from the educational course master 12b (FIG. 5A) and transmits to and displays at the consumer terminal apparatus 20 contents as shown in FIG. 15B (for example, through transmitting an e-mail or Web data) to implement the education (e-learning) for each student, customer, or consumer.

When the education is finished, the educating unit 13b provides an examination (confirming test) for testing an effect of the education on the student and registers into the education master 12c (FIG. 6) a result of the confirming test as an education history. The result registered may include the date of finishing the test, the test result, the flag, and a keyword. The educating unit 13b transmits or sends to the consumer terminal apparatus 20 of the student who has finished the test information including a product or a list of products that is/are discounted as result of completing the educational course via means such as a direct mail.

The education server apparatus 10 then transmits the information that has been registered in the education master 12c to the store server apparatus 30. The store server apparatus 30 receives and stores the information into an education master 32c in synchronization with the education server apparatus 10.

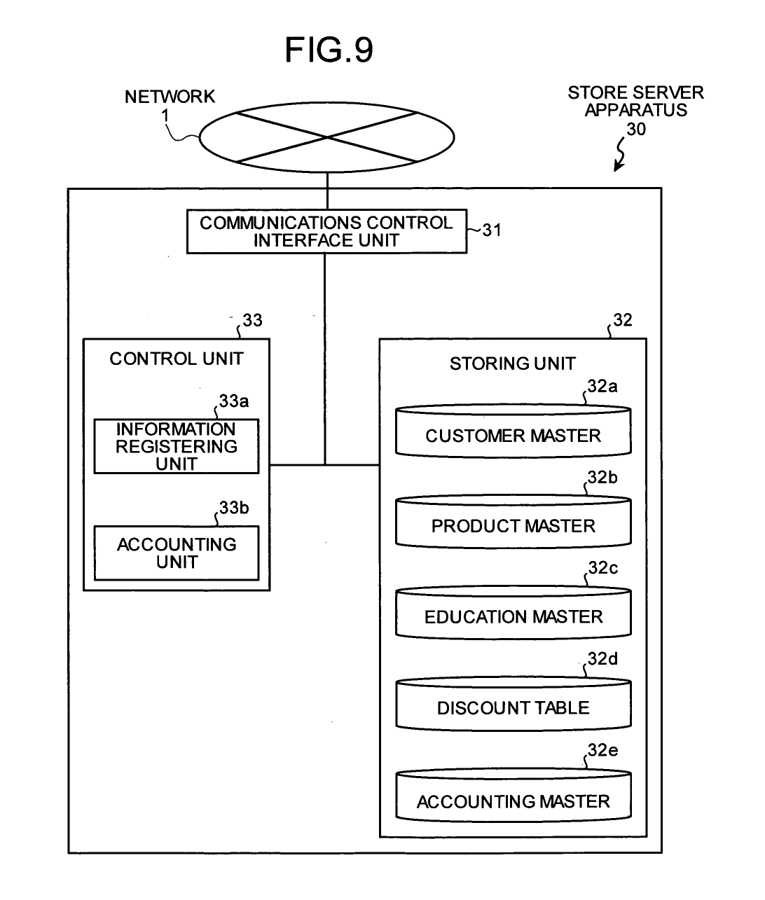

A structure of and processes executed at the store server apparatus 30 in the educational system according to the first embodiment is now explained with reference to FIGS. 9 to 13. FIG. 9 is a block diagram of the structure of the store server apparatus 30. The store server apparatus 30 includes a communications control interface unit 31 that controls communications related to data exchanged between the store server apparatus 30 and the consumer terminal apparatus 20 and between the store server apparatus 30 and the education server apparatus 10 via the network. The store server apparatus 30 also includes a storing unit 32 and a control unit 33, which are explained in detail below.

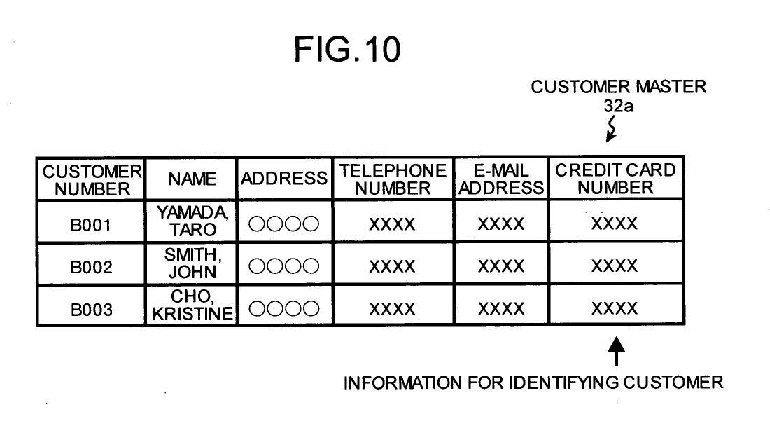

The storing unit 32 is a storing means (memory means) that stores data (for example, Web data transmitted to and displayed at the consumer terminal apparatus 20) and a program required for various processes executed by the control unit 33. The storing unit 32 functionally has a customer master 32a, a product master 32b, an education master 32c, a discount table 32d, and an accounting master 32e, which are elements closely related to the present invention. The customer master 32a is a means for storing various pieces of personal information related to a consumer (customer). For example, as shown in FIG. 10, a name, an address, a telephone number, an e-mail address, and a credit card number are stored in the customer master 32a correspondingly with a customer number for each consumer. Information same as that stored in the customer master 12a of the education server apparatus 10 may be stored in the customer master 32a in synchronization with the customer master 12a.

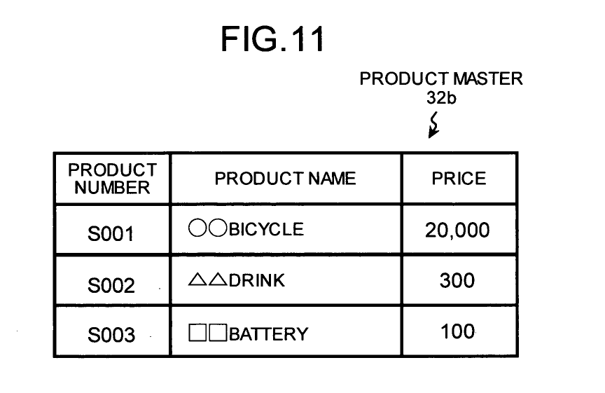

The product master 32b is a means that stores various pieces of information related to merchandises or products sold by the store server apparatus 30. For example, as shown in FIG. 11, a product name and a price may be stored correspondingly with a product number for each product in the product master 32b.

The education master 32c stores a progress of the education that has been implemented on the student, in synchronization with the education master 12c of the education server apparatus 10. The education master 32c is structured in the same manner as the education master 12c illustrated in FIG. 6. The discount table 32d is a means for storing information related to discounts provided as a result of completing the courses. The discount table 32d is structured in the same manner as the discount table 12d illustrated in FIG. 7.

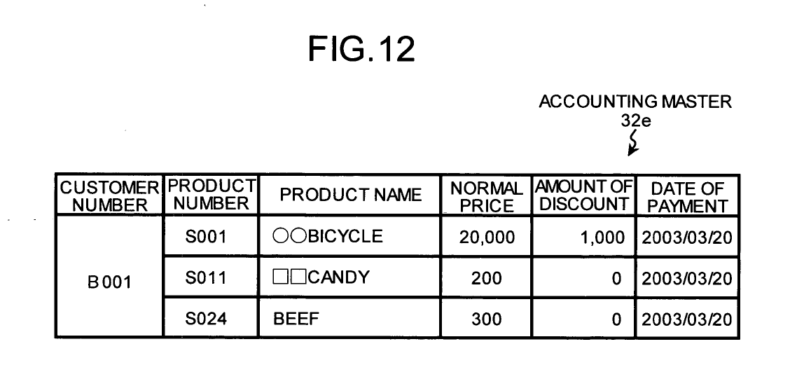

The accounting master 32e is a means for storing various pieces of information related to a sales performance achieved by the store server apparatus 30. As shown in FIG. 12, a product number, a product name, a normal price, an amount of discount, and a date of payment for the product sold to each customer is stored correspondingly with a customer number of the customer.

The control unit 33 of the store server apparatus 30 illustrated in FIG. 9 is a processing unit that includes an internal memory for storing a control program such as an operating system and a program which defines various processes (for example a program for authenticating a customer) and data. The control unit 33 executes various processes using these programs and data. The control unit 33 functionally includes an information registering unit 33a and an accounting unit 33b, which are elements closely related to the present invention.

The information registering unit 33a is a processing unit that registers corresponding information into the customer master 32a, the product master 32b, the education master 32c, the discount table 32d, and the accounting master 32e of the storing unit 32. The information registering unit 33a registers the information into the accounting master 32e in cooperation with the accounting unit 33b.

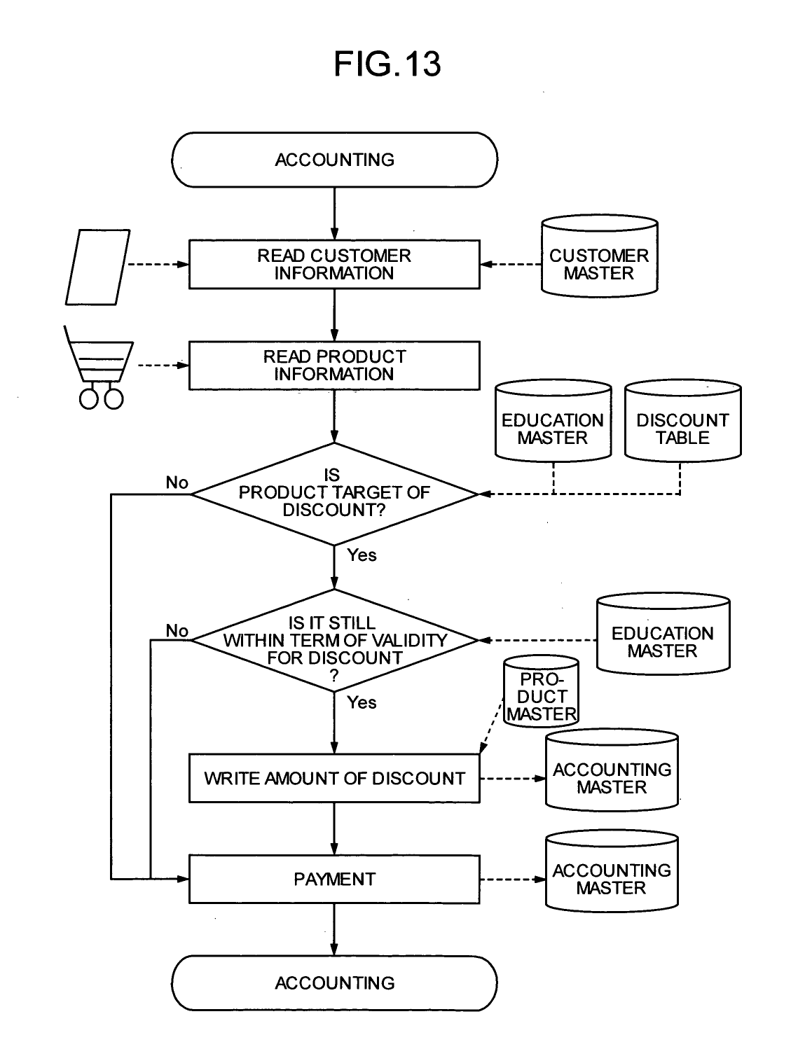

The accounting unit 33b is a processing unit that executes various steps related to selling of products (discount sales based on implementation of educational courses) as illustrated in FIG. 13. Firstly, the accounting unit 33b reads customer information and product information related to a requested product input from the consumer terminal apparatus 20 of the consumer, and determines whether the requested product is a target of discount. That is, the accounting unit 33b refers to the education master 32c and the discount table 32d and determines whether an educational course corresponding to the requested product the customer is wishing to purchase has been completed by the customer.

Next, the accounting unit 33b determines whether it is within a term for which the discount is valid. For example, this term may be set to be one year from a date of finishing test stored in the education master 32c. The accounting unit 33b then refers to the discount table 32d to calculate an amount of discount of the requested product and registers the amount into the accounting master 32e (see FIG. 12). The accounting unit 33b also registers other data related to accounting or payment such as time and date of the payment and a total amount of the payment into the accounting master 32e to finish the accounting procedure.

While the first embodiment has been described, the present invention can be implemented as various types of different embodiments within the scope of the technical ideas defined in the claims. Some of these embodiments are now explained with examples of products, education, benefits to consumers, system configurations, and programs.

Although the educational system according to the first embodiment above is described mainly for products that are targets of recycling, the present invention is not limited to such products. For example, the educational system may be implemented similarly for various products that become useless or end up being refuses and require to be properly disposed of by consumers. These refuses may include kitchen refuses, large-size refuses, and industrial wastes.

According to the first embodiment, the educational course (educational contents) is selected by the customer but the present invention is not limited to such selection. A selection of a product (such as a product which the customer is planning to purchase) may be received from the customer before implementing an educational course corresponding to a disposal of that product based on the selection. As a result, by implementing an educational .course on how to separate and throw out refuses in accordance with a material a product is made of, for example, a consumer is able to understand how to dispose of the product more suitably and more in accordance with a type of the product.

The education may be implemented for the customer in accordance with a district or area selected by the customer because rules for separating and throwing out refuses vary among different self-governing bodies. These rules may be educated in accordance with living areas of consumers. As a result, the consumers are able to understand how to dispose of products more suitably in accordance with the area in which the product is disposed of. Postal codes and telephone numbers may be used for the selection of these areas.

Subjects of study that have been already studied by a consumer in the past may be omitted, or certain subjects may be studied intensively in accordance with an education history. As a result of implementing suitable education in accordance with the history of education, the consumer's understanding can be efficiently enhanced continuously. For example, if a second bicycle is to be purchased after the purchase of a first bicycle, educational contents that have been studied with respect to the purchase of the first bicycle may be omitted from target of education for the second bicycle. If a customer has moved to a new address in a different residential district in which a method of disposal of a product is different from that in a former residential district, an education history may be compared with the new address of the customer or an area selected so that the customer can be informed of an educational course required to be studied.

According to the first embodiment, the education is implemented after an access from the consumer who sees the product label shown in FIG. 14 and is interested in the educational course by the label but the present invention is not limited to this access. For example, an advertising mail for an educational course may be sent to a consumer terminal apparatus 20 of a consumer to encourage the consumer to take the course. The present invention may be implemented for a case in which a self-governing body requires consumers to take an educational course.

According to the first embodiment, customers who have taken the educational courses (educational contents) that are related to the discounts and passed the examinations are indiscriminately provided with the discounts but the present invention is not limited to this example. For instance, discount rates may be increased or decreased in accordance with results of the examinations. That is, if an examination score obtained is high, the discount rate is increased. More specifically, for example, if a full discount rate is 5% and a score of an examination is 90 marks, a discount rate may be set to 5% multiplied by 0.9, making 4.5%. As a result, by supplying consumers with profits in accordance with results (scores or marks) of examinations, consumers' motivation to study can be stimulated even more.

According to the first embodiment, discounts on products purchased are provided as benefits or profits to consumers (students) but the present invention is not limited to this example. For example, benefits to consumers may be provided similarly by giving out coupons that can be used when products are purchased, adding points to so-called “mileage cards”, or giving out points equivalent to monetary values.

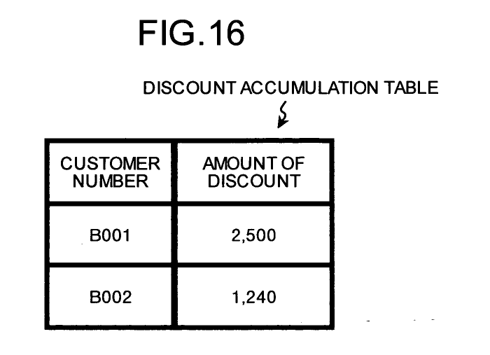

Such benefits may not only be provided for purchase of products but also may be specific to districts or areas selected by consumers. That is, for example, a discount accumulation table as shown in FIG. 16 may be maintained at the education server apparatus 10 to return taxes at once from self-governing bodies when tax returns are filed by consumers. Such public profits obtained from self-governing bodies act as an incentive to socially stimulate consumers' motivation to study the educational courses.

According to the first embodiment, discounts are given as benefits to students on condition that corresponding educational courses are completed by the students, but various other conditions may be applied. For example, it can be verified whether a consumer has properly disposed of a product based on an IC chip attached to the product to give out such a benefit to the consumer on condition that proper disposal of the product has been carried out.

According to the first embodiment, a consumer accesses the store server apparatus 30 from the consumer terminal apparatus 20 to purchase a product on-line, but the consumer may visit a store to directly purchase the product instead. In the latter case, the customer may be requested to show a registered card to be identified at the time of payment.

According to the first embodiment, the education server apparatus 10 and the store server apparatus 30 are separately provided on the network 1 in the system, but the apparatuses may be integrated into a unitary structure in the system. Having these apparatuses separately on the network 1 though effectively increases efficiency of the education because products from a plurality of stores can be handled together, and effectively maintains publicness and neutralness of the education server apparatus 10 as an educational institution, which may be managed privately or publicly by a self-governing body.

Each structural element of the apparatuses illustrated in the drawings is only for functional illustration of the apparatuses and thus are not necessarily structured physically as shown in the drawings. In other words, specific examples of separation and integration of any of the elements and the apparatuses are not limited to those illustrated in the drawings. At least one of the elements and the apparatuses may be functionally and physically separated or integrated in any units depending on various loads and states in which they are used. At least one of the processing functions executed by the apparatuses may be realized by a central processing unit (CPU) and a computer program that is analyzed and executed by the CPU. Further, at least one of the processing functions may be provided as hardware using wired logic.

Furthermore, at least one of the steps which are described to be automatically executed according to the first embodiment may be manually performed, and at least one of the steps which are described to be manually performed according to the first embodiment may be automatically executed by a known method. Moreover, the processing steps, the control steps, specific names, and information including various data and parameters, which are described above and illustrated in the drawings, may be arbitrarily modified unless specified on the contrary.

In addition, a computer program may be executed by a computer system such as a personal computer or a workstation to realize the various processes described according to the first embodiment. Such a computer system that executes a computer program with similar functions to those of the first embodiment is explained below.

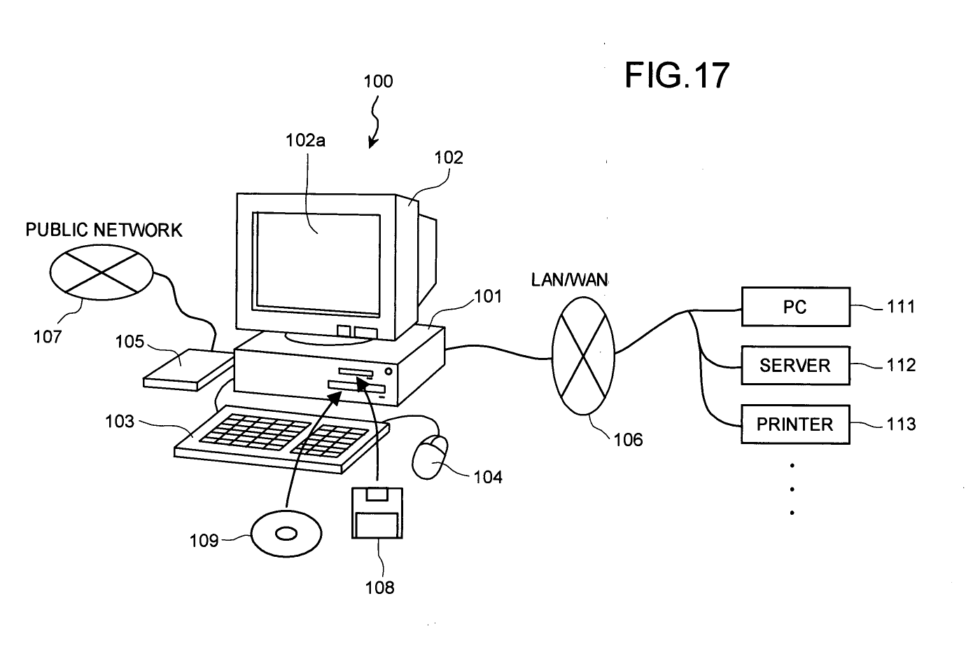

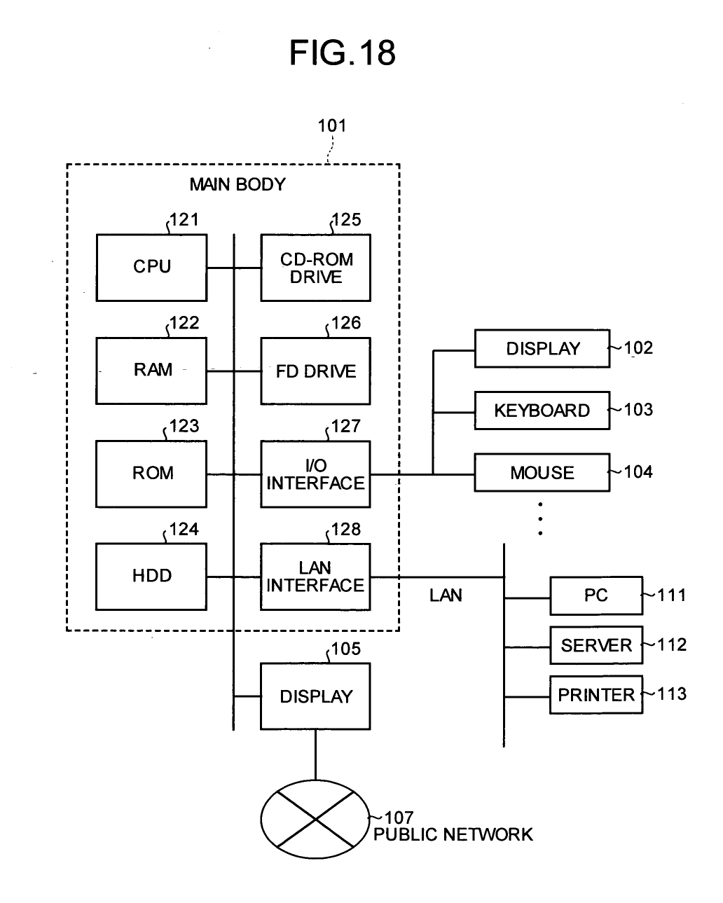

FIG. 17 is a diagram of a structure of a computer system according to a second embodiment of the present invention. FIG. 18 is a block diagram of a structure of a main body of the computer system. The computer system 100 as shown in FIG. 17 includes a main body 101, a display 102 that displays various pieces of information such as images on a display screen 102a based on instructions from the main body 101, a keyboard 103 for inputting various pieces of information into the computer system 100, and a mouse 104 for specifying an arbitrary position on the display screen 102a of the display 102.

The main body 101 of the computer system 100, as shown in FIG. 18, includes a CPU 121, a random access memory (RAM) 122, a read only memory (ROM) 123, a hard disk drive (HDD) 124, a compact disk-read only memory (CD-ROM) drive 125 for a CD-ROM 109, a floppy disk (FD) drive 126 that receives a flexible disk (FD) 108, an input/output interface 127 that connects a display 102, a keyboard 103, and a mouse 104, and a local-area-network (LAN) interface 128 that connects to a LAN 106 or a wide area network (WAN) 106.

The computer system 100 is connected with a modem 105 for connecting to a public network 107 such as the Internet. The computer system 100 is also connected with another personal computer (PC) 111, a server 112, and a printer 113, via the LAN interface 128 and the LAN/WAN 106.

The computer system 100 reads and executes a computer program recorded in a recording medium to realize the functions of the first embodiment. This recording medium may be any medium capable of storing a computer program readable by the computer system 100. For example, the recording medium may be a “portable physical medium” such as the FD 108, the CD-ROM 109, a magneto-optical (MO) disk, a digital versatile disk (DVD), or an integrated-circuit (IC) card. Otherwise, the recording medium may be a “fixed physical medium” such as the HDD 124, the RAM 122, or the ROM 123, which is provided inside or outside the computer system 100. Yet otherwise, the recording medium may be a “communications medium” that temporarily holds the computer program when transmitting the computer program, such as a public network 107 to be connected to via the modem 105 or the LAN/WAN 106 to which the another computer system 111 and the server 112 are connected.

That is, the computer program according to the another embodiment is recorded on the recording medium such as the mobile physical medium, the fixed physical medium, or the communications medium so that the computer program is computer-readable. The computer system 100 realizes the functions of the first embodiment by reading and executing the computer program from the recording medium. The computer program according to the second embodiment is not limited to be executed by the computer system 100 but may also be executed by another computer system 111 or the server 112. The computer system 11 and the server 112 may also execute the computer program in cooperation with each other.

As described above, according to the present invention, the consumer's understanding related to the disposal of the product can be facilitated, to urge the consumer to actively cooperate in effectively utilizing resources and contributing to a clean environment. As a result, manufacturers and self-governing bodies are able to pay less for environmental problems and to facilitate effective utilization of resources and contribution to a clean environment.

Furthermore, according to the present invention, education suitable for the type of the product selected by the consumer can be implemented. For example, how to throw out or separate products as refuses may be educated in accordance with materials the products are made of. As a result, the consumer is able to understand how to dispose of the product more suitably and more in accordance with the type of the product.

Moreover, according to the present invention, the education can be implemented suitably in consideration of the district or area selected by the customer. For example, how to separate and throw out products as refuses may be taught in accordance with living areas of consumers. As a result, the consumers are able to understand how to dispose of products more suitably in accordance with the area in which the product is disposed of.

Furthermore, according to the present invention, subjects of study that have been already studied by the consumer in the past may be omitted, or certain subjects may be studied intensively in accordance with the education history. As a result of implementing suitable education in accordance with the education history in this way, the consumer's understanding can be efficiently enhanced continuously.

Moreover, according to the present invention, motivation of the consumer who receives the education can be stimulated by the examination, and the level of the consumer's understanding can be represented objectively by the result of the examination. Accordingly, the consumer is able to understand about the disposal better and more firmly.

Furthermore, according to the present invention, certain benefits to be given to the consumer can act as an incentive to the consumer's motivation to receive the education. Consequently, the consumer's understanding can be improved more effectively.

Moreover, according to the present invention, the benefit directly provided to the consumer at the time of selling the product can act as an incentive to directly stimulate the consumer's motivation to receive the education. As a result, the consumer's understanding can be improved even more effectively.

Furthermore, according to the present invention, for example, taxes can be returned at once as the benefit from self-governing bodies when tax returns are filed by consumers so that such public profits obtained from self-governing bodies can act as an incentive to socially stimulate consumers' motivation to study.

Moreover, according to the present invention, discount rates may be increased or decreased in accordance with a result of the examinations as long as the consumers pass the examinations. That is, if an examination score obtained is high, the discount rate is increased. As a result, by supplying consumers with profits in accordance with results (scores or marks) of examinations, consumers' motivation to study can be stimulated even more.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. An apparatus for providing various pieces of information related to a product that requires a proper disposal by a consumer to a client apparatus of the consumer via a network, the apparatus comprising:
an educating unit that conducts an education related to a disposal of the product for the consumer via the client apparatus; and
an education-history storing unit that stores a progress of the education conducted, as an education history.

2. The apparatus according to claim 1, wherein the educating unit conducts the education corresponding to a type of a product selected by the consumer.

3. The apparatus according to claim 1, wherein the educating unit conducts the education corresponding to a district selected by the consumer.

4. The apparatus according to claim 1, wherein the educating unit conducts the education based-on the education history stored.

5. The apparatus according to claim 1, wherein
the educating unit conducts a test on the education for the consumer, and
the education-history storing unit stores a result of the test as a part of the education history.

6. The apparatus according to claim 1, further comprising a benefit providing unit that provides a predetermined benefit to the consumer who took the education, based on the education history stored.

7. The apparatus according to claim 6, wherein the benefit providing unit provides at least one of a discount, a coupon, and a point, which is applicable to purchase the product, as the predetermined benefit.

8. The apparatus according to claim 6, wherein
the educating unit conducts the education corresponding to a district selected by the consumer, and
the benefit providing unit provides a benefit that is applicable within the district selected by the consumer, as the predetermined benefit.

9. The apparatus according to claim 5, further comprising a benefit providing unit that provides a predetermined benefit to the consumer who took the education, based on the education history stored, wherein
the benefit providing unit provides a benefit corresponding to the result of the test, as the predetermined benefit.

10. A method of providing various pieces of information related to a product that requires a proper disposal by a consumer to a client apparatus of the consumer via a network, the method comprising:
conducting an education related to a disposal of the product for the consumer via the client apparatus; and
storing a progress of the education conducted, as an education history.

11. A computer-readable recording medium that stores a computer program for providing various pieces of information related to a product that requires a proper disposal by a consumer to a client apparatus of the consumer via a network, wherein the computer program causes a computer to execute
conducting an education related to a disposal of the product for the consumer via the client apparatus; and
storing a progress of the education conducted, as an education history.
